(19) United States
(12) Patent Application Publication
(10) Pub. No.: US 2005/0284915 A1
(43) Pub. Date: Dec. 29, 2005

(54) Apparatus and method for indexing of substrates and lead frames

(76) Inventors: David T. Beatson, Kennett Square, PA (US); Richard Deward Sadler, Quakertown, PA (US); Mohamad Yusoff Aziz, Singapore (SG); Arindam Sinharoy, Furlong, PA (US)

Correspondence Address: RATNERPRESTIA, P O BOX 980, VALLEY FORGE, PA, 19482-0980, US

(21) Appl. No.: 11/152,130

(22) Filed: Jun. 14, 2005

Related U.S. Application Data
(60) Provisional application No. 60/579,806, filed on Jun. 15, 2004.

(51) Int. Cl. B23K 37/00; B23K 31/02

(52) U.S. Cl. 228/4.5; 228/180.5; 228/49.5

(57) ABSTRACT

An apparatus for manipulating a work piece in connection with a wire bonding machine including at least one magazine handler is provided. The apparatus includes a first conveyor system configured to receive work pieces from the at least one magazine handler, and a second conveyor system configured to receive work pieces from the at least one magazine handler. The apparatus is adapted such that the second conveyor system prepares a work piece for a wire bonding operation by a wire bonding tool concurrent with the first conveyor system supporting another work piece during a wire bonding operation of the another work piece using the wire bonding tool.

### CROSS REFERENCE TO RELATED APPLICATIONS

This application claims the benefit of priority to U.S. Provisional Patent Application No. 60/579,806, filed on Jun. 15, 2004, the contents of which are incorporated in this application by reference.

### FIELD OF THE INVENTION

This invention relates generally to wire bonding equipment. More specifically, the present invention relates to an apparatus and process for indexing and bonding electronic components with increased throughput.

### BACKGROUND OF THE INVENTION

Modern electronic equipment relies heavily on printed circuit boards on which semiconductor chips, or integrated circuits (ICs), are mounted. The mechanical and electrical connections between the chip and the substrate have posed challenges for chip designers.

The most common of these processes is wire bonding. In wire bonding, a plurality of bonding pads are located in a pattern on the top surface of the substrate, with the chip mounted in the center of the pattern of bonding pads, with the top surface of the chip facing away from the top surface of the substrate. Fine wires (e.g., aluminum, copper, or gold wires) are connected between the contacts on the top surface of the chip and the contacts on the top surface of the substrate.

Chip scale packages (CSPs) offer a solution to the challenge of shrinking the size of semiconductor devices relative to the size of the chip (die) contained in the package. Typically, the CSP size is between 1 and 1.2 times the perimeter size of the die, or 1.5 times the area of the die. The CSP offers a compact size near that of a bare die or flip chip technology, and offers greater reliability, because the CSP need not suffer from the same thermal expansion incompatibility problems which are known in flip chips.

Most CSPs use a flexible, sheetlike interposer (e.g., a polyimide film or tape), having fine, flexible wiring embedded therein. The fine wirings in the interposer end at peripheral terminals near the periphery of the chip when the chip is mounted on the interposer. An example is the Micro Ball Grid Array (Micro BGA) design. The wirings redistribute the peripheral terminals of the interposer to a grid array of solder ball lands that cover the interior area of the chip. The chip is mounted on the interposer, and the plurality of terminals in the interposer are bonded to the plurality of contacts on the periphery of the chip using a conventional bonding technique, such as ultrasonic bonding. Once bonded, the terminals may be encapsulated for protection using an elastomeric encapsulant that permits flexible movement of the terminals during thermal cycling due to differential expansion between the chip and the substrate. The solder balls are then formed on lands on the top surface of the interposer, and the individual chip packages are cut from the tape. The ball grid array can be evenly spaced at the minimum required pitch for solder connections to the substrate (which may be of the order of 0.5 mm between balls), achieving a high density of contacts. Because the interposer has a ball grid array covering most of the surface area of the chip, the BGA design results in a package size that is nearly as small as the chip itself.

There is a drawback, however, in using BGA or Micro BGA devices with respect to the wire bonding process. Specifically, BGA devices typically require longer heat up time to bonding temperature, ultimately affecting throughput when using conventional work-holder designs. Further, BGA devices do not have “downsets”, and there are no “lead-fingers” available for clamping. These aspects of the BGA material are considered in the simplified approach in this innovation. Mechanisms built into existing work-holder designs to address “downsets” and clamping of “lead-fingers” not only add to the complexity of the design but also constrain the throughput due to their effects on the system dynamics. Accordingly, there is a need for a work-holder design that ensures adequate and uniform heating of BGA devices, affords significant simplification of automatic work-holder designs, and therefore reduced cost of goods, while enhancing throughput through having a heated strip as a buffer in the material flow.

### SUMMARY OF THE INVENTION

According to an exemplary embodiment of the present invention, an apparatus for manipulating a work piece in connection with a wire bonding machine including at least one magazine handler is provided. The apparatus includes a first conveyor system configured to receive work pieces from the at least one magazine handler, and a second conveyor system configured to receive work pieces from the at least one magazine handler. The apparatus is adapted such that the second conveyor system prepares a work piece for a wire bonding operation by a wire bonding tool concurrent with the first conveyor system supporting another work piece during a wire bonding operation of the another work piece using the wire bonding tool.

According to another exemplary embodiment of the present invention, an apparatus for supplying work pieces to a wire bonding machine for use with at least one magazine handler is provided. The apparatus includes an indexer having a portion that couples to the at least one magazine handler. The indexer includes a first conveyor portion, a second conveyor portion adjacent the first conveyor portion, at least one heater disposed below the first and second conveyor portions, and at least one vacuum disposed below the first and second conveyor portions to maintain work pieces against an upper surface of the conveyor portions. The first and second conveyor portions are configured to receive work pieces from the at least one magazine handler. The apparatus is configured to load a second work piece onto the second conveyor portion while a first work piece is being at least one of (1) heated by the at least one heater or (2) wire bonded by the wire bonder.

According to yet another exemplary embodiment of the present invention, a method of wire bonding work pieces is provided. The method includes (1) wire bonding a work piece supported by a first conveyor portion using a wire bonding tool of a wire bonding machine, (2) heating another work piece supported by a second conveyor portion during step (1), (3) moving the second conveyor portion to a position where the another work piece supported by the second conveyor portion is adjacent the wire bonding tool while moving the first conveyor portion to a position away from the wire bonding tool, and (4) wire bonding the another work piece supported by the second conveyor portion using the wire bonding tool.

According to yet another exemplary embodiment of the present invention, a method for supplying work pieces to a wire bonding machine is provided including the steps of initializing a magazine handler and an indexer into respective first positions; loading a first work piece from the magazine handler onto a first conveyor portion of the indexer; repositioning the magazine handler to a second position; repositioning the indexer so as to locate the first work piece within a bonding portion of the wire bonding machine; loading a second work piece onto a second conveyor of the indexer substantially simultaneously with the first work piece being wire bonded by the wire bonding machine; repositioning the magazine handler to the first position; repositioning the indexer so as to locate the second work piece within the bonding portion of the wire bonding machine and locate the first work piece to an unload position; unloading the first work piece onto the magazine handler from the first conveyor substantially simultaneously with the second work piece being wire bonded by the wire bonding machine; loading a further work piece from the magazine handler onto the first conveyor; repositioning the magazine handler to the second position; repositioning the indexer so as to locate the further work piece within the bonding portion of the wire bonding machine; and unloading the second work piece from the second conveyor onto the magazine handler substantially simultaneously with the further work piece being wire bonded by the wire bonding machine.

### BRIEF DESCRIPTION OF THE DRAWINGS

The invention is best understood from the following detailed description when read in connection with the accompanying drawing. It is emphasized that, according to common practice, various features of the drawings are not to scale. On the contrary, the dimensions of various features are arbitrarily expanded or reduced for clarity. Included in the drawings are the following Figures:

FIG. 1 is a perspective view of an exemplary embodiment of the present invention;

FIG. 2 is a left side elevation view of the exemplary embodiment of FIG. 1;

FIG. 3 is front elevation view of the exemplary embodiment of FIG. 1;

FIG. 4A is a perspective view of a first exemplary conveyor according to the present invention;

FIG. 4B is a perspective view of an alternate exemplary embodiment for a gripper of the present invention;

FIG. 5 is a perspective view of a conveyor according to an exemplary embodiment of the present invention;

FIG. 6 is a front view of the conveyor of FIG. 5;

FIG. 7A is a perspective view of a first exemplary gripper according to an embodiment of the present invention;

FIG. 7B is a perspective view of a second exemplary gripper according to an embodiment of the present invention;

FIG. 8 is an exploded view of a heat block portion of the conveyor of FIG. 5; and

FIGS. 9-16 are illustrations of a process cycle flow according to an exemplary embodiment of the present invention.

### DETAILED DESCRIPTION OF THE INVENTION

As used herein, the term “work piece” is intended to refer to any device that is configured to undergo a wire bonding operation, including but not limited to substrates (e.g., including substrates with a plurality of semiconductor devices thereon or integrated therein), leadframes, semiconductor devices (e.g., dies, chips), interposers, and combinations thereof.

As used herein, the term “wire bonding a work piece” refers to the application of at least one wire bond or wire loop to the work piece, even if the work piece ultimately will include a plurality of wire bonds or wire loops. According to certain exemplary embodiments of the present invention, a wire bond may be applied to a work piece (using a wire bonding tool) on a first conveyor (or conveyor portion), and then, before the remaining wire bonds are applied to the work piece, a wire bond may be applied to another work piece on a second conveyor using the wire bonding tool. Of course, the present invention also contemplates applying all of the desired wire bonds to a first work piece (using a wire bonding tool) on a first conveyor and then applying all of the desired wire bonds to another work piece on a second conveyor using the wire bonding tool.

As used herein, the term “magazine handler” is intended to refer to any system through which work pieces are presented to an indexer (e.g., an indexer including a conveyor system). The term is not intended to be limited to systems that present the work pieces in any particular arrangement or configuration.

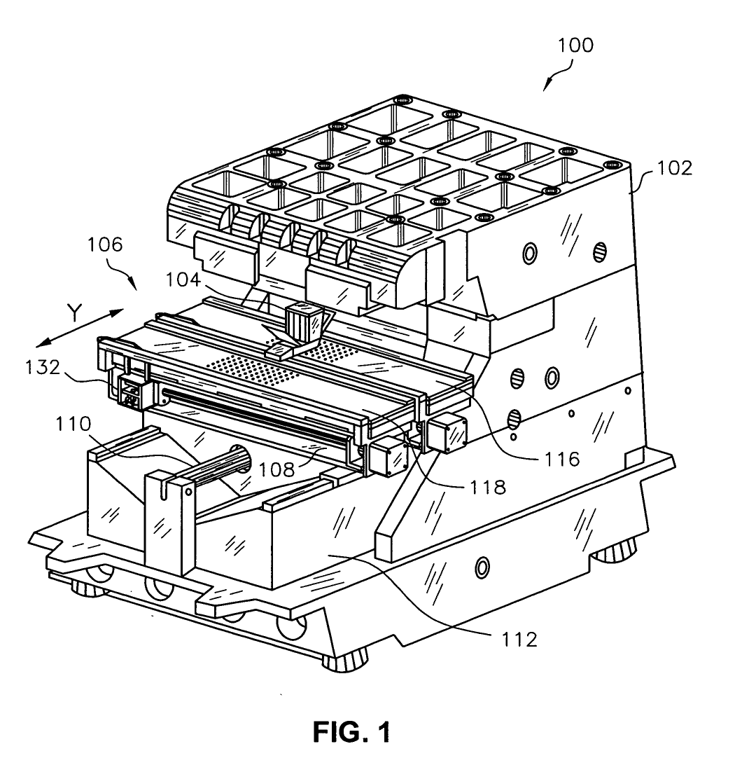

FIG. 1 illustrates a perspective view of an exemplary embodiment of the present invention. For clarity, the magazine handler system that stores and presents/receives work pieces before and after processing is not shown in this figure. As shown in FIG. 1, bonding system 100 comprises a bonding head structure 102 which includes a bonding head 104 disposed on a front portion thereof. Below bonding head 104 is the inventive shuttling dual workholder 106 mounted on support block 108. Workholder 106 and support block 108 move in a Y direction along rail 110 with respect to support base 112. Bonding head 104 remains stationary with respect to the X and Y axes while dual workholder 106 shuttles back and forth in the direction of arrow Y. Dual workholder 106 includes a first conveyor system 116 and a second conveyor system 118 disposed along side one another. The details of conveyor system 116 and 118 are described below.

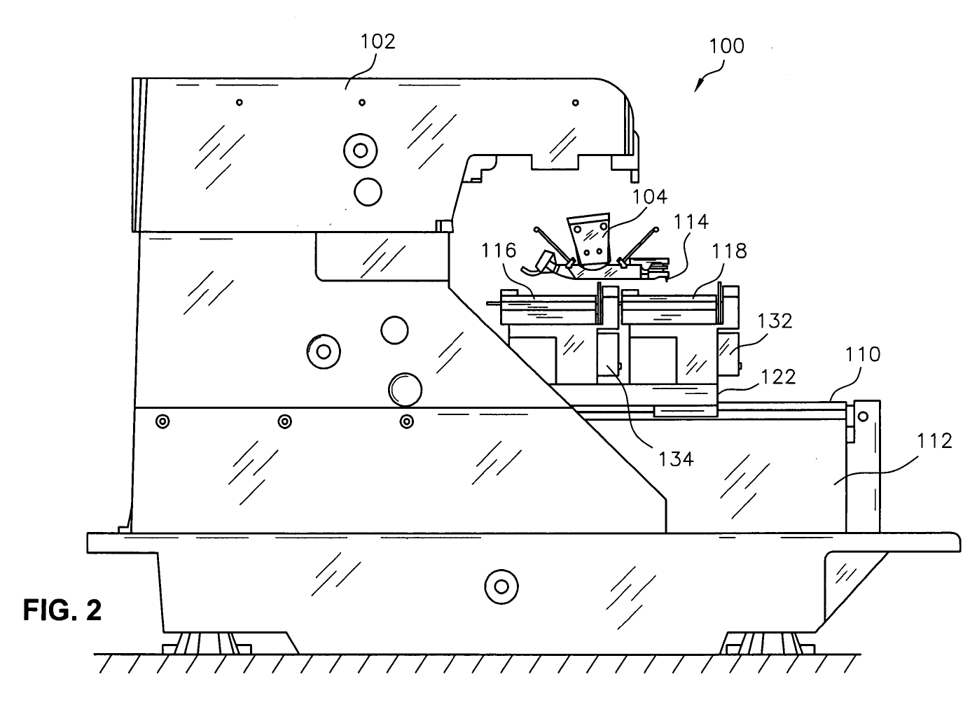

FIG. 2 illustrates a left side view of bonding system 100. As shown in FIG. 2, conveyor systems 116 and 118 are spaced apart from one another such that the center lines of respective conveyor systems 116 and 118 are desirably about 4.5 inches apart. The invention is not so limited as this distance may be adjusted as necessary to meet design considerations. Adjacent each conveyor system 116 and 118 is a fixed front rail 120. As shown in FIG. 2, and for purposes of explanation, the dual workholder assembly is in a rearward position such that conveyor system 118 is positioned below bonding tool 114. As can be appreciated, as linear slide 122 of support block 108 moves forward along rail 110, conveyor 118 will move away from bonding tool 114 while conveyor 116 moves toward bonding tool 114. In this way, work pieces (not shown in this figure), which are detachably mounted to conveyors 118 and 116, may be bonded.

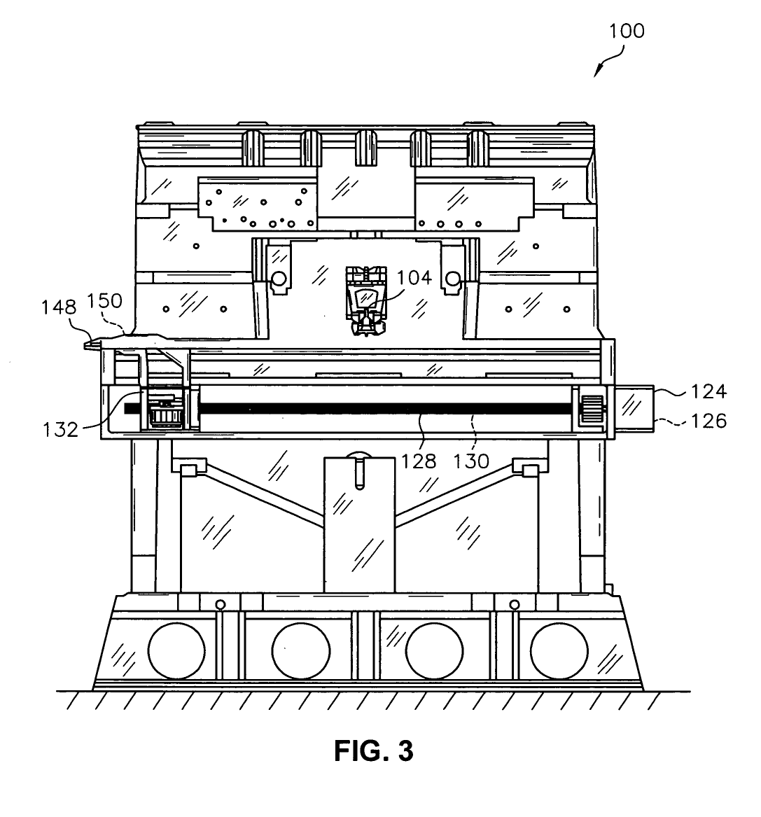

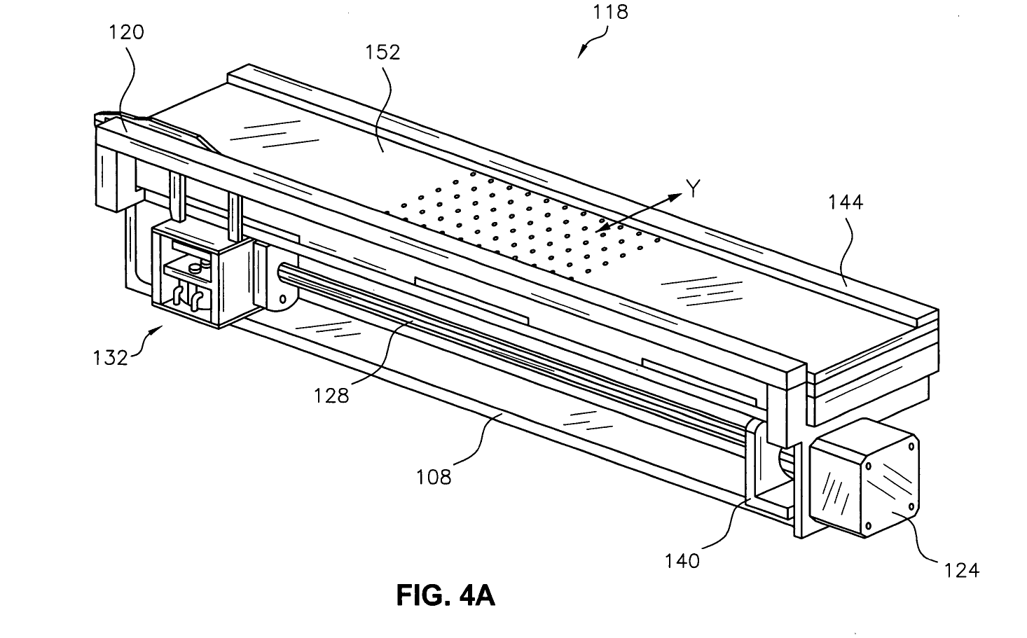

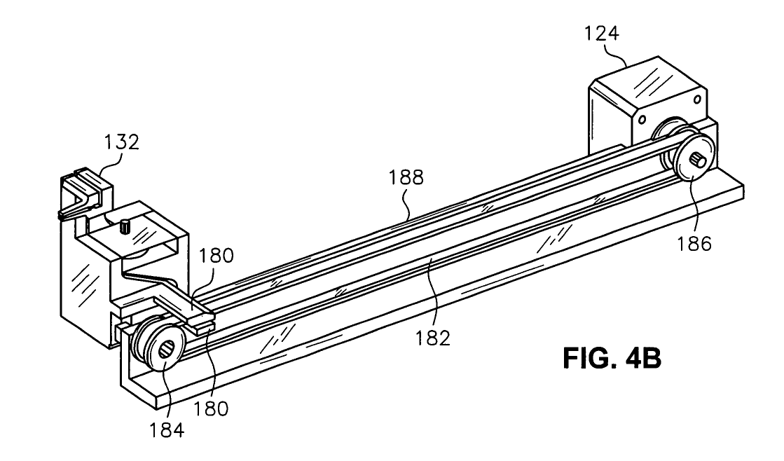

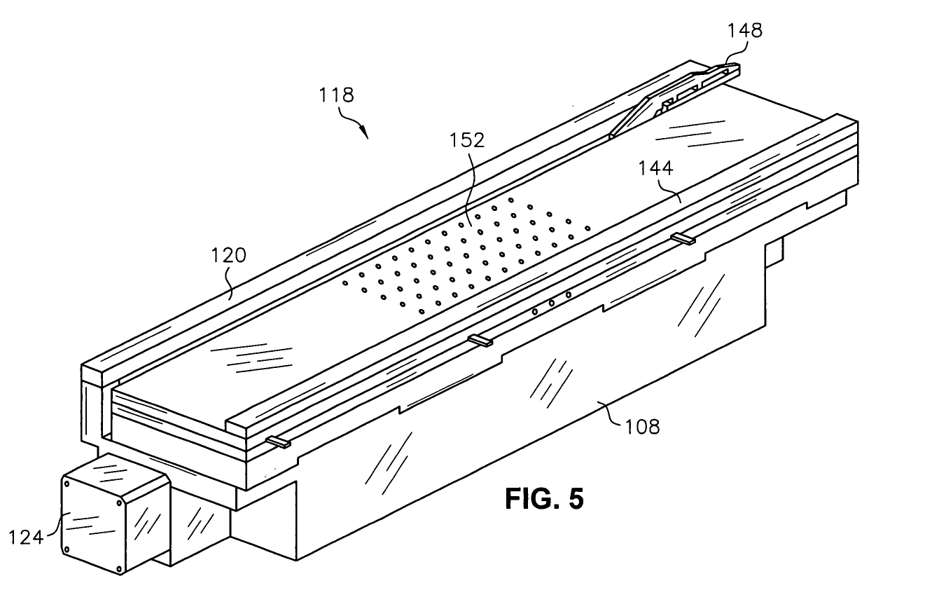

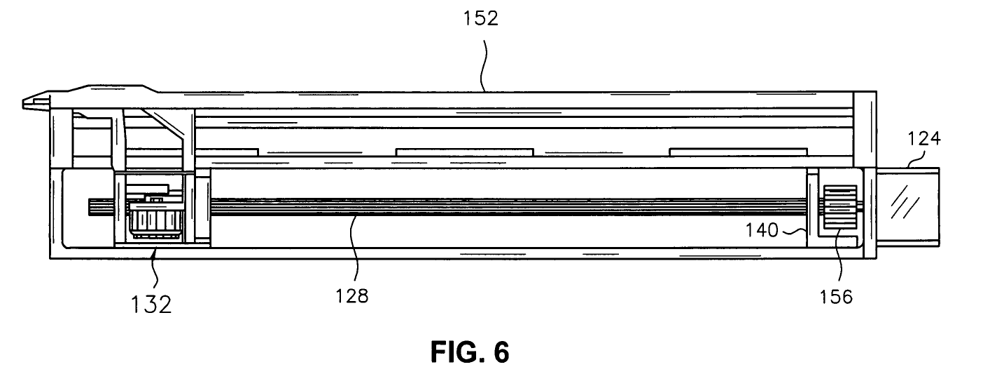

FIG. 3 illustrates a front elevation view of bonding system 100, FIG. 4A is a front perspective view of one of conveyors 116, 118, FIG. 5 is a rear perspective view of one of conveyors 116, 118, and FIG. 6 is a front view of one of conveyors 116, 118. As shown in FIGS. 3, 4A, 5 and 6, puller/gripper/tucker 132 (for conveyor 118, also shown in FIG. 1) and 134 (for conveyor 116) are disposed along a front portion of the respective conveyors 116, 118. For purposes of the following discussion, only puller/gripper/tucker 132 and its associated parts (e.g., lead screw 128, jaw assembly 148, and stepper motor 124) will be referred to for simplicity, but it is recognized that the explanation is equally applicable for puller/gripper/tucker 134 and its associated components (e.g., lead screw 130, jaw assembly 150, and stepper motor 126).

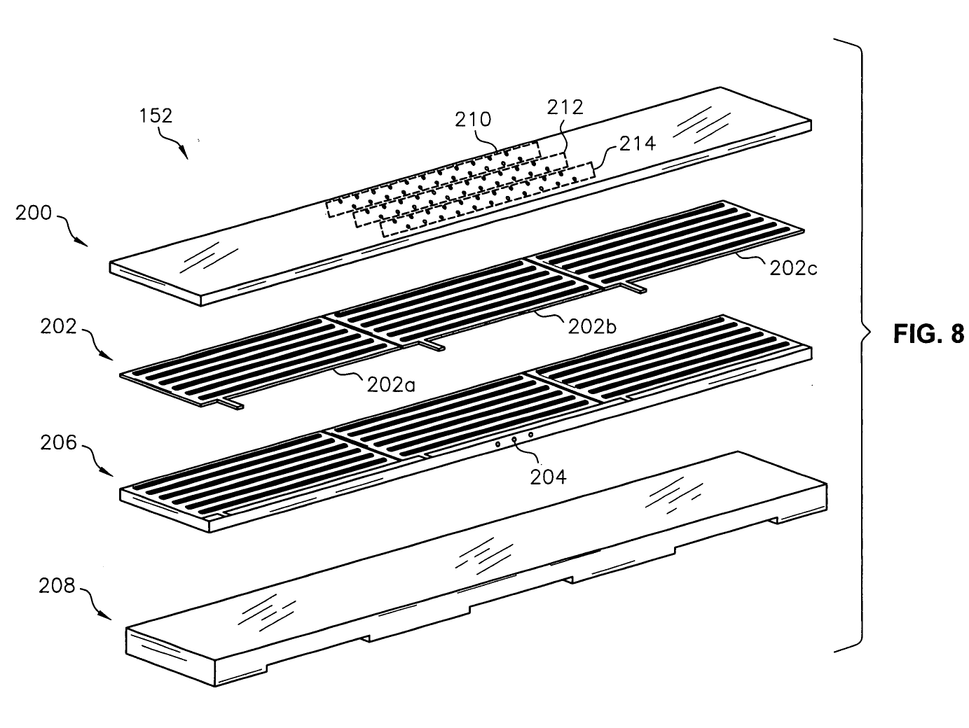

Puller/gripper/tucker 132 travels along lead screw 128 in a direction orthogonal to that of workholder 106 and support block 108. Jaw assembly 148 is coupled to the housing of puller/gripper/tucker 132 and, in one exemplary embodiment, is disposed between front rail 120 and the side of platen heat block 152. Stepper motor 124 is coupled to one end of lead screw 128 by coupler 156. In operation, when stepper motor 124 is activated, lead screw 128, which is supported at one end by bearing support 140, rotates in turn moving puller/gripper/tucker 132 along lead screw 128 toward the right side of the figure (See, e.g., FIGS. 4A and 6). As will be described further below, jaw assembly 148 is used to grasp onto a portion of a work piece from a supply of work pieces. Thus, as puller/gripper/tucker 132 moves along lead screw 128, the work piece will move along the surface of platen heat block 152 ultimately for bonding by bonding tool 104. Conversely, to eject a work piece, stepper motor 124 is operated in a reverse direction to move the work piece back toward the supply magazine (not shown). Referring again to FIG. 5, rear rail 144 may be adjustable in a Y direction to accommodate work pieces of varying widths. A detailed description of platen heat block 152, 154 will be addressed below with respect to FIG. 8.

Although a stepper motor and lead screw are illustrated in FIGS. 4A and 6, the invention is not so limited as it is contemplated that a pulley and belt assembly, for example, may be used to move puller/gripper/tucker 132 as desired. Such an approach is illustrated in FIG. 4B. As shown in FIG. 4B, puller/gripper/tucker 132 is coupled to stepper motor 124 with timing belt 182 via belt clamp 180. In operation, when stepper motor 124 is activated, pulley 186 turns which moves timing belt 182 (and pulley 184), in turn directing puller/gripper/tucker 132 along slide rail 188. To return puller/gripper/tucker 132 to its initial position, stepper motor 124 is reversed.

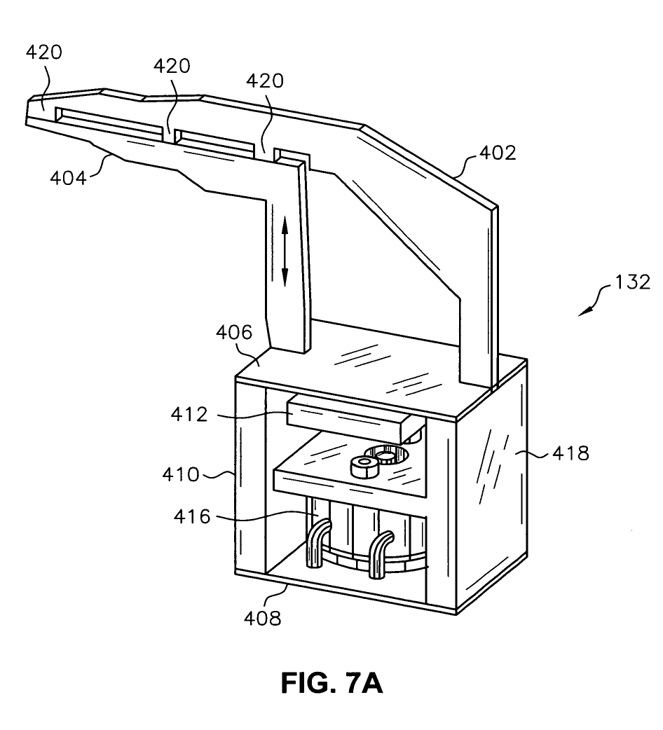

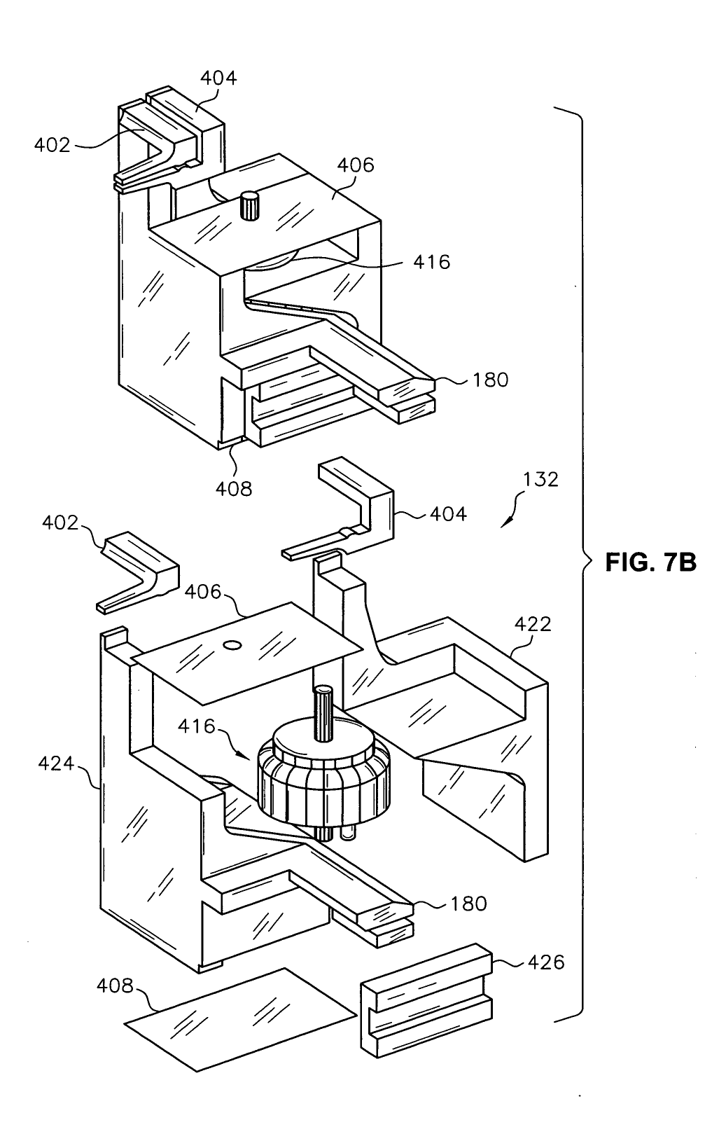

FIG. 7A is a perspective view of a first exemplary embodiment of puller/gripper/tucker 132, 134. As shown in FIG. 7A, puller/gripper/tucker 132, 134 comprises fixed upper jaw 402 and movable lower jaw 404 disposed against one another. Fixed upper jaw 402 has grip points or teeth 420 disposed along a portion of the length of fixed upper jaw 402. These grip points or teeth 420 and the surface of movable lower jaw 404 contact a work piece, such as a ball grid array (BGA) assembly or lead frame, as desired to move the work piece along the conveyor. Fixed upper jaw 402 is coupled to fixed support 418 at a top portion thereof. Movable support arm 410 is spaced apart from and coupled to fixed support 418 with upper leaf spring 406 and lower leaf spring 408. Leaf springs 406 and 408 permit movable support 410 to articulate in the Z direction (as indicated by the double headed arrow) with respect to fixed support 418. As such, movable lower jaw 404, which is coupled to movable support arm 410, will likewise move in the Z direction with respect to fixed upper jaw 402, thereby permitting a BGA or lead frame to be gripped by upper and lower jaws 402, 404 as desired.

In one exemplary embodiment, to effect the movement of movable support arm 410 and movable lower jaw 404, an actuator 416, such as a solenoid or a voice coil motor is used. In the exemplary embodiment, actuator 416 is disposed on an upper service of lower leaf spring 408 and coupled to beam 412, which is in turn is coupled to movable support arm 410. Upon activation of actuator 416, beam 412 is drawn closer to the frame of actuator 416 in turn moving support arm 410 downward in the Z direction, which in turn moves lower jaw 404 away from fixed upper jaw 402 opening a space between movable lower jaw 404 and grip points 420 so that an article, such as a BGA assembly or lead frame, may be positioned between the opening of upper and lower jaws 402, 404. Once the lead frame or BGA assembly (not shown) is in place, actuator 416 is de-energized, thereby moving jaw 404 closer to fixed upper jaw 402 such that the BGA or lead frame is grabbed between fixed upper jaw 402 and movable lower jaw 404.

Referring now to FIG. 7B a second exemplary puller/gripper/tucker 132 is illustrated. As shown in FIG. 7B, this exemplary puller/gripper/tucker is for use with the belt drive system illustrated in FIG. 4B and comprises fixed gripper jaws 402 coupled to upper bracket 424, moveable lower jaws 404 coupled to lower bracket 422, leaf springs 406, 408 coupled between lower bracket 422 and upper bracket 424, belt clamp 180 coupled to upper bracket 424, slide block 426 coupled to upper bracket 424 and actuator 416 disposed between upper bracket 424 and lower bracket 422. In operation slide block 426 is coupled to and moves along slide rail 188 (shown in FIG. 4B). Operation of the jaw assemblies 402, 404 is similar to the embodiment described above with respect to FIG. 7A and is not repeated here.

Referring now to FIG. 8, a exploded perspective view of platen heat block 152 is illustrated. As shown in FIG. 8, heat block 152 comprises top heat plate 200, preferably made of a light weight metal, such as aluminum, lower heat plate 206, also formed from a lightweight metal, such as aluminum, heaters 202 disposed between top heat plate 200 and lower heat plate 206, and insulator plate 208, desirably formed from a ceramic material, disposed below lower heat plate 206. In one exemplary embodiment, heaters 202 are desirably formed in a flat configuration from a foil type resistive heating element. In addition, to accomplish a desirable temperature ramp up and ramp down as the work piece moves along the heat block 152, heaters 202 are configured into stages, such as a preheat stage 202a, bond site heat stage 202b, and post bond stage 202c. Although three heaters 202a, 202b, 202c are illustrated, it is contemplated that a single heater may be used to accomplish these functions.

As the work piece is draw along the surface of platen heat block 152 by puller/gripper/tucker 132, the first stage of platen heat block 152 will preheat the work piece in preparation for bonding. As the work piece moves further along the surface of platen heat block 152, the work piece will be subject to a higher temperature in preparation for bonding by bond head 104 (see FIG. 1). In order to maintain the work piece in position during bonding, the surface of platen heat block 152 includes vacuum zones 210, 212, 214, which receive a source of vacuum (not shown). In one exemplary embodiment, vacuum zone 210, 212, 214 extend partially into the preheat zone and post heat zone. In one exemplary embodiment, the vacuum source is coupled to a central portion of bottom heat plate 206 via inlet tubes 204. Each inlet tube is coupled in fluid tight relationship with a respective one of vacuum zones 210, 212, 214.

In operation, when a work piece is put into place for bonding, vacuum is applied to a lower portion of the work piece to hold it in place against the surface of top heat plate 200. This serves two purposes. One is to ensure adequate heat transfer to the work piece during bonding and the second is to prevent the work piece from moving during bonding. Once bonding is completed on the work piece, the vacuum is removed and the work piece is moved toward the post bond portion of the platen heat block 152 to allow for the work piece to gradually cool down prior to further processing.

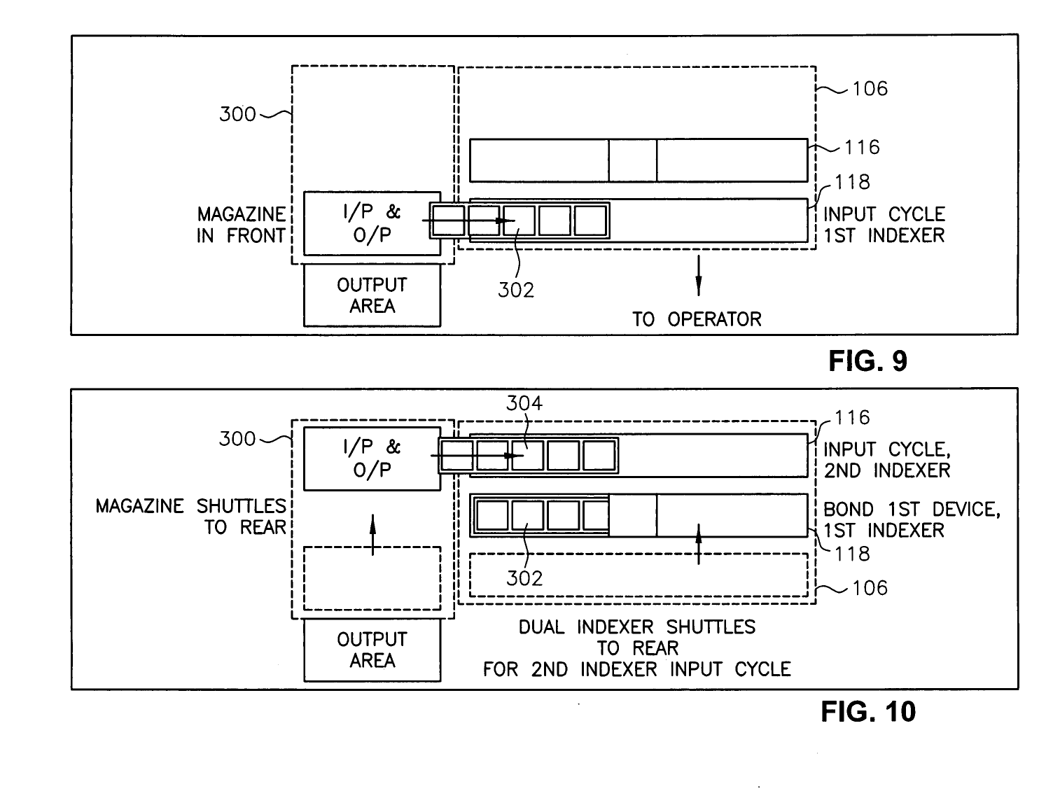

As can be appreciated, for work pieces that are coupled to one another using a substrate or other type of coupling, as the first work piece is being bonded, subsequent work piece(s) are being preheated. Once bonding of the first work piece is completed, a subsequent work piece is moved into place as the first work piece is moved away from the bonding site and vacuum is applied for bonding this subsequent work piece. This process desirably continues until all work pieces are bonded or the process is otherwise terminated. This process is best illustrated in FIGS. 9-16 and described below.

Referring now to FIG. 9, in an initial configuration magazine handler 300 presents a work piece 302 having a plurality of devices to be pulled into front conveyor 118 of dual workholder 106. Work piece 302 will then be moved along the surface of front conveyor 118 with puller/gripper/tucker 132 (not shown in this figure). As device 302 is being moved along front conveyor 118, it is being preheated prior to bonding. For simplicity, it will be assumed for this description that rear conveyor 116 is initially empty.

As shown in FIG. 10, both magazine handler 300 and dual workholder 106 are repositioning rearward to a second position so that front conveyor 118 is positioned under bond head 104. As work piece 302 is being processed, a second work piece 304 is loaded onto rear conveyor 116 with puller/gripper/tucker 134 (not shown in this figure) for preheating prior to bonding.

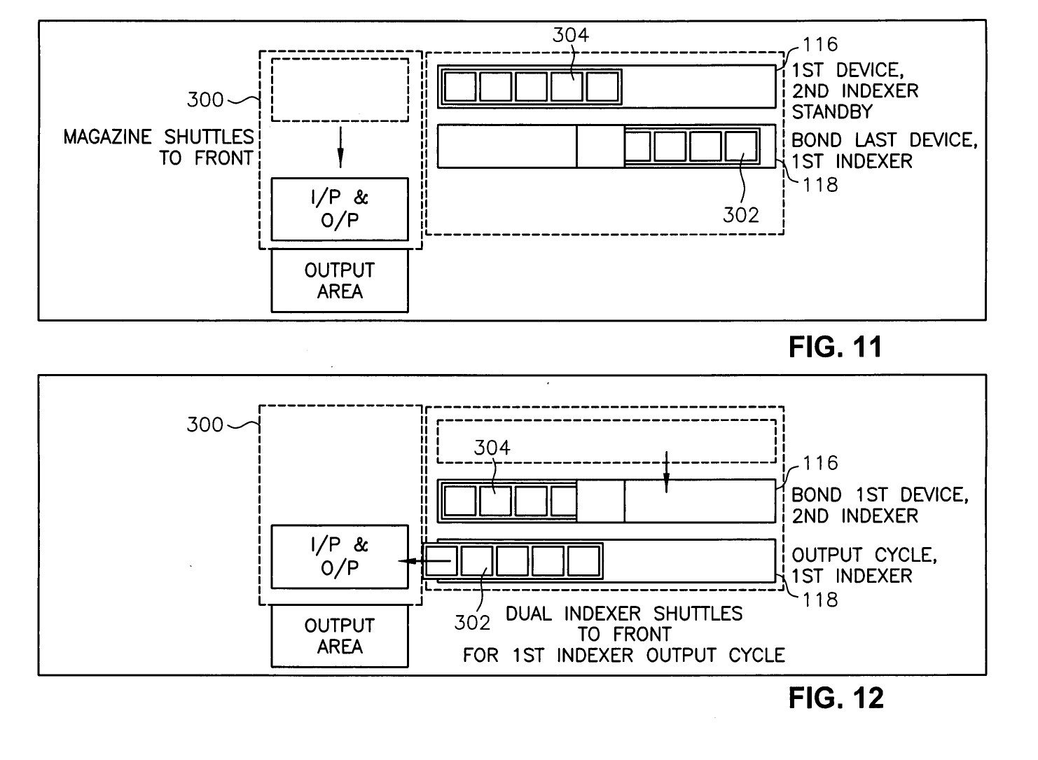

As shown in FIGS. 11 and 12, once the last device of work piece 302 is bonded dual workholder 106 is moved forward so as to position conveyor 116 under bond head 104. As shown in FIG. 12, as work piece 304 is being processed (moving from left to right), work piece 302 is being unloaded into magazine handler 300 by puller/gripper/tucker 132 for further processing. These two processes occur substantially, if not completely, simultaneous with one another. Further, and as discussed above, as work piece 302 is being unloaded it goes through a controlled cool down while passing over post-heat zone and preheat zone of heat platen 152.

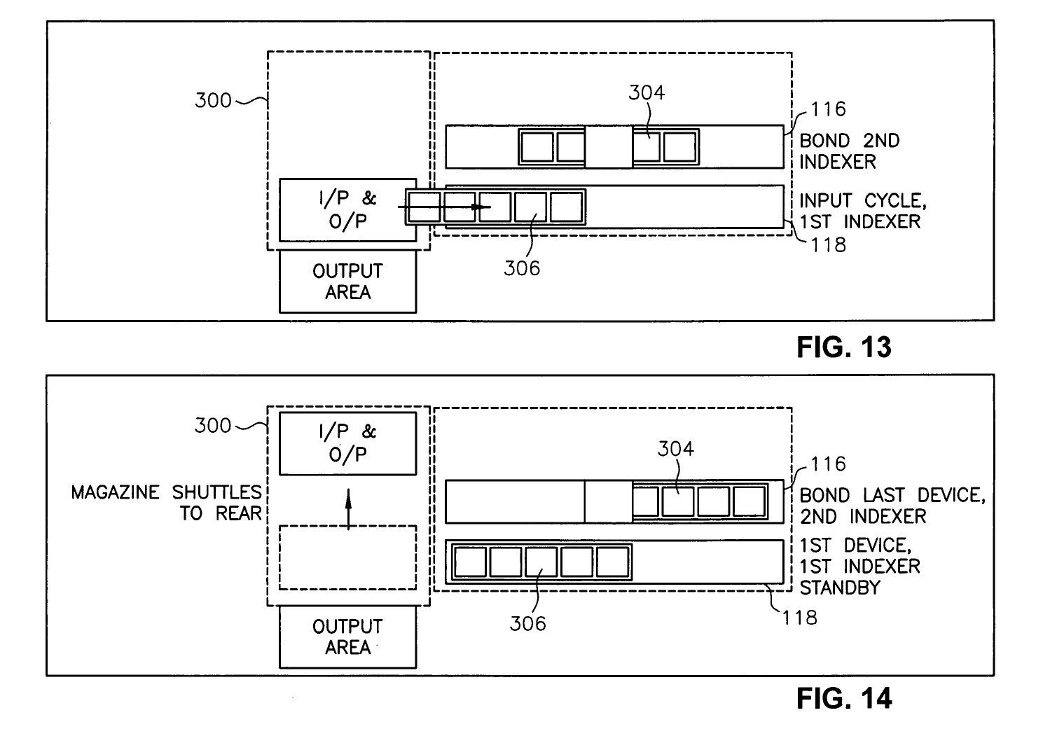

As shown in FIG. 13, as work piece 304 is being processed a third work piece 306 is loaded onto front conveyor 118 with puller/gripper/tucker 132 for preheating prior to bonding.

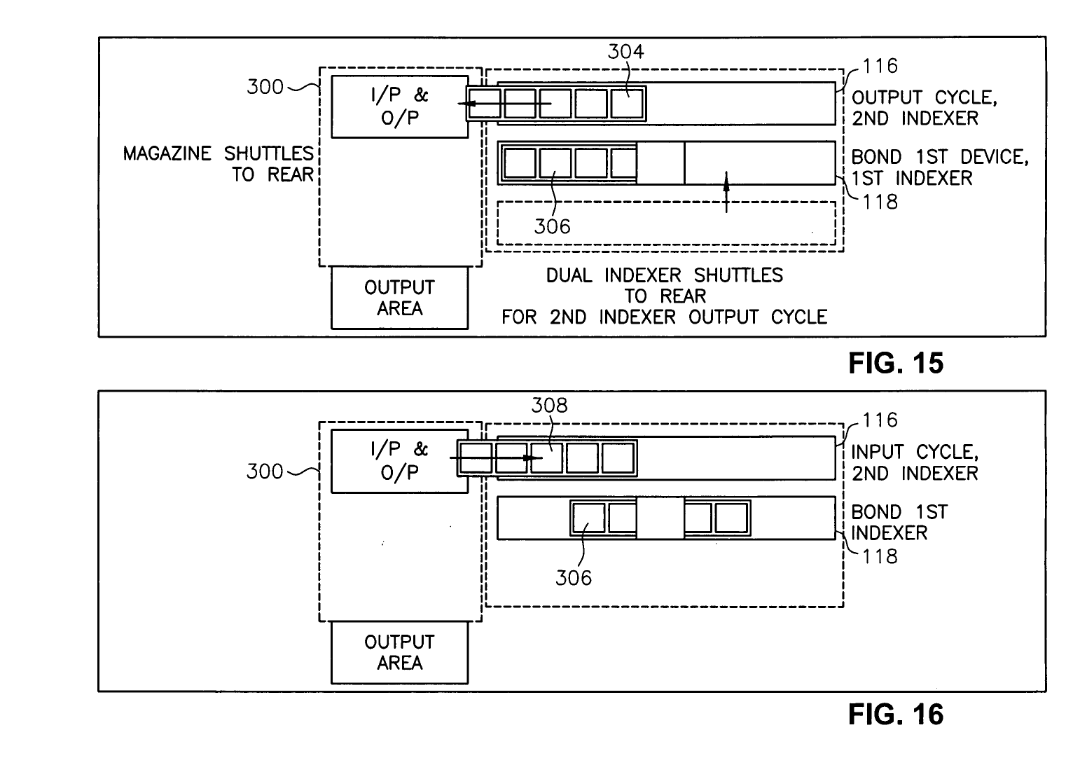

As shown in FIGS. 14-16, once the last device of work piece 304 is bonded, dual workholder 106 is moved rearward so as to position conveyor 118 under bond head 104. As shown in FIG. 15, as work piece 306 is being processed (moving from left to right), work piece 304 is being unloaded into magazine handler 300 by puller/gripper/tucker 134 for further processing. These two processes occur substantially, if not completely, simultaneous with one another. Further, and as discussed above, as work piece 304 is being unloaded it goes through a controlled cool down while passing over post-heat zone and preheat zone of heat platen 152. Next, and as illustrated in FIG. 16, as processing continues on work piece 306 yet another work piece 308 is being loaded onto rear conveyor 116 for processing.

This process may be repeated as desired until all work pieces contained in magazine handler 300 are bonded. Thus, as can be appreciated, the exemplary system and process increase throughput of BGA and/or leadframe devices.

Although the present invention has been illustrated primarily with respect to two parallel conveyor systems (e.g., conveyors 116 and 118) it is not limited thereto. Alternative arrangements of conveyor systems (e.g., non-parallel) are within the scope of the present invention. Further, the present invention is not limited to two conveyors. For example, in certain arrangements three or more conveyors arranged with respect to a wire bonding system may be practical and efficient.

Although the invention is illustrated and described herein with reference to specific embodiments, the invention is not intended to be limited to the details shown. Rather, various modifications may be made in the details within the scope and range of equivalents of the claims and without departing from the invention.

1. An apparatus for manipulating a work piece in connection with a wire bonding machine including at least one magazine handler and a wire bonding tool, the apparatus comprising:
a first conveyor system configured to receive work pieces from the at least one magazine handler; and
a second conveyor system configured to receive work pieces from the at least one magazine handler, the apparatus being adapted such that the second conveyor system prepares a work piece for a wire bonding operation by the wire bonding tool concurrent with the first conveyor system supporting another work piece during a wire bonding operation of the another work piece using the wire bonding tool.

2. The apparatus of claim 1 wherein each of the first conveyor system and the second conveyor system are configured to be moved between (1) a first position adjacent the wire bonding tool for the wire bonding operation, and (2) a second position away from the wire bonding tool.

3. The apparatus of claim 1 additionally comprising at least one heater disposed below the first conveyor system and the second conveyor system, and wherein the apparatus is adapted such that the second conveyor system prepares the work piece by at least one of (1) heating the work piece or (2) positioning the work piece.

4. The apparatus of claim 1 wherein the apparatus is adapted such that the first conveyor system prepares a first work piece for a wire bonding operation by the wire bonding tool concurrent with the second conveyor system supporting a second work piece during a wire bonding operation of the second work piece by the wire bonding tool.

5. The apparatus of claim 1 additionally comprising a slide rail system for providing substantially horizontal motion of the apparatus with respect to the wire bonding machine.

6. The apparatus of claim 1 additionally comprising a first gripping device moveably coupled to the first conveyor system and configured to grip a first work piece and move the first work piece along the first conveyor system, and a second gripping device moveably coupled to the second conveyor system and configured to grip a second work piece and move the second work piece along the second conveyor system.

7. An apparatus for supplying work pieces to a wire bonding machine for use with at least one magazine handler, the apparatus comprising:
an indexer having a portion that couples to the at least one magazine handler, the indexer comprising:
a first conveyor portion,
a second conveyor portion adjacent the first conveyor portion,
at least one heater disposed below the first and second conveyor portions, and
at least one vacuum disposed below the first and second conveyor portions to maintain work pieces against an upper surface of the conveyor portions; and
the first and second conveyor portions being configured to receive work pieces from the at least one magazine handler;
wherein the apparatus is configured to load a second work piece onto the second conveyor portion while a first work piece is being at least one of (1) heated by the at least one heater or (2) wire bonded by the wire bonder.

8. The apparatus of claim 7 wherein the apparatus is configured to cyclically move the first conveyor portion and the second conveyor portion such that during a cycle (1) the first conveyor portion is moved into a first position where a work piece on the first conveyor portion is wire bonded by the wire bonding machine and the second conveyor portion is moved to a second position to receive a further work piece from the at least one magazine handler, and (2) the second conveyor portion is moved into the first position where the further work piece on the second conveyor portion is wire bonded by the wire bonding machine and the first conveyor portion is moved to the second position to receive yet a further work piece from the at least one magazine handler.

9. The apparatus of claim 7 additionally comprising a slide rail system for providing substantially horizontal motion of the indexer with respect to the wire bonding machine.

10. The apparatus of claim 7 additionally comprising a first gripping device moveably coupled to the first conveyor portion and configured to grip a work piece and move the work piece along the first conveyor portion, and a second gripping device moveably coupled to the second conveyor portion and configured to grip a further work piece and move the further work piece along the second conveyor portion.

11. A method of wire bonding work pieces for use with a wire bonding machine and a wire bonding tool, the method comprising:
(1) wire bonding a work piece supported by a first conveyor portion using the wire bonding tool of the wire bonding machine;
(2) heating a further work piece supported by a second conveyor portion during step (1);
(3) moving the second conveyor portion to a position where the further work piece supported by the second conveyor portion is adjacent the wire bonding tool while moving the first conveyor portion to a position away from the wire bonding tool; and
(4) wire bonding the further work piece supported by the second conveyor portion using the wire bonding tool.

12. The method of claim 11 wherein step (2) further comprises at least one of (a) positioning the work piece supported by the second conveyor portion to a predetermined position on the second conveyor portion or (b) applying a vacuum to the work piece supported by the second conveyor portion.

13. The method of claim 11 further comprising:
(5) receiving, at the first conveyor portion, yet another work piece to be supported by the first conveyor portion after step (3);
(6) positioning the yet another work piece at a predetermined location on the first conveyor portion after step (5);
(7) heating the yet another work piece on the first conveyor portion after step (5); and
(8) wire bonding the yet another work piece using the wire bonding tool after step (4).

14. A method for supplying work pieces to a wire bonding machine, the method comprising:
a) initializing a magazine handler and an indexer into respective first positions;
b) loading a first work piece from the magazine handler onto a first conveyor portion of the indexer;
c) repositioning the magazine handler to a second position;
d) repositioning the indexer so as to locate the first work piece within a bonding portion of the wire bonding machine;
e) loading a second work piece onto a second conveyor of the indexer substantially simultaneously with the first work piece being wire bonded by the wire bonding machine;
f) repositioning the magazine handler to the first position;
g) repositioning the indexer so as to locate the second work piece within the bonding portion of the wire bonding machine and locate the first work piece to an unload position;
h) unloading the first work piece onto the magazine handler from the first conveyor substantially simultaneously with the second work piece being wire bonded by the wire bonding machine;
i) loading a further work piece from the magazine handler onto the first conveyor;
j) repositioning the magazine handler to the second position;
k) repositioning the indexer so as to locate the further work piece within the bonding portion of the wire bonding machine; and
l) unloading the second work piece from the second conveyor onto the magazine handler substantially simultaneously with the further work piece being wire bonded by the wire bonding machine.

15. The method according to claim 14, further comprising repeating steps e) through l) as desired.

16. The method according to claim 14, further comprising applying a vacuum to the first work piece after the first work piece is located within the bonding portion of the wire bonding machine.

17. The method according to claim 16, further comprising successively removing and reapplying the vacuum to the first work piece as various portions of the first work piece are moved into and away from the bonding portion of the wire bonding machine.

18. The method according to claim 16, further comprising removing the vacuum from the first work piece prior to step (h).
